(19) United States
(12) Patent Application Publication
(10) Pub. No.: US 2006/0081708 A1
(43) Pub. Date: Apr. 20, 2006

(54) Modular RFID label dispensing apparatus

(76) Inventors: Craig Blonigen, Andover, MN (US); Chad Modesette, New Richmond, WI (US); Matt Thoreson, Stillwater, MN (US); Daryl Norgard, North Branch, MN (US); Ed Schreiner, St. Paul, MN (US); Ken Koehler, Frederic, WI (US); Dan Murtin, Minneapolis, MN (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/965,221

(22) Filed: Oct. 15, 2004

(51) Int. Cl. G06K 7/08

(52) U.S. Cl. 235/451

(57) ABSTRACT

A method and apparatus for accepting operative RFID labels for application to an object, and for rejecting inoperative labels. The RFID labels are peelably adhered to a carrier web. When operative, the RFID label produces a response to an input signal. A tranceiver produces the input and is responsive to the output to activate a peeler. The peeler is pivotally mounted for rotation between an extended position and a retracted position. When extended, the peeler engages the web to separate the RFID label therefrom in response to the RFID output. When retracted, the peeler disengages the web whereby the RFID label remains adhered thereto.

### BACKGROUND

The invention relates to a selectable label dispensing apparatus. More particularly, the invention relates to a labelling apparatus for selectively applying or rejecting Radio Frequency Identification Device (RFID) labels to advancing articles.

As hereinafter understood, RFIDs are minature electronic transponder devices which are hard wired or programmable to produce an output signal in response to an input signal. RFIDs typically have identifying indicia. RFIDs may also contain other information, including product identification, pricing information, and information which enables manufacturers, shippers, and retailers to track the products in commerce. The term RFID may be used herein with or without the designation ‘transponder’, but it should be understood that the term RFID includes the transponder designation.

Label dispensing devices for applying conventinal labels to advancing articles have come into widespread use in a variety of industries. These devices include print-and-appy label dispensing systems that print and apply labels to advancing articles on demand. Apply-only systems utilize pre-printed labels. Label dispensing devices for RFID labels have not come into widespread use because of the for reasons discussed below.

At present, due to their cost, RFID transponders are used on high end products. Typically, the RFID is programmed with the product information and identification data; tested for operability; and applied to the product. At present, these operations are performed manually. However, as the cost of RFIDs decreases, it is expected that their use will become more widespread in the market place. However, before such widespread use becomes a reality, it will be necessary to devise means for efficiently encoding, verifying, and applying operable labels to advancing articles.

### SUMMARY OF THE INVENTION

The present invention is based upon the discovery of apparatus for selectively applying radio frequencey identification devices (RFID) onto advancing articles and accordance with the operability of the label.

In an exemplary embodiment, the apparatus includes a frame having a bearing surface and a working end. An RFID label is carried on a carrier web. A retractable peeler is pivotally mounted on the frame adjacent the working end. The peeler is positionable between an advanced peel position, forward of the workng end and a retracted, reject position behind the working end. The peeler engages the underside of the carrier web, causing the label to separate from the web when the peeler is in the advanced position. The peeler is retractable to the reject position, disengaging the underside of the web, to thereby allow the RFID label to be carried past the peeler and remain on the carrier web as a reject.

The peeler is formed of a plurality of axially mounted wedge shaped elements, each having a distal peeler edge for engaging the web and a proximal pivot. The wedges are mounted in spaced relation along a shaft which is rotatably secured to the frame so that each peeler edge is rotatable about the shaft axis between respective peel and reject positions. A bearing surface engages the under side of the web and the working end is formed with a relatively smooth rounded surface for engaging the underside of the web when the peeler is in the reject position, so that the label remains attached to the web for disposal.

Another exemplary embodiment of the invention is an apparatus for selecting and deselecting RFID labels adhered to the carrier surface of a web to a dispensing location between a supply hub and a rewind hub. The RFID labels are disposed on the carrier surface of the web in spaced relation. The labels are responsive to a verification signal, to produce an output indicative of an operative label. The labels are selected for application at the dispensing location to advancing articles in response to the verification signal, or the labels are deselected or rejected for retention on the carrier when the verification signal is absent.

In a particular embodiment, a position sensor upstream of the dispenser location detects each RFID label. A transponder produces an output signal for activating the detected RFID label and for receiving the verification signal.

In another embodiment, the RFID transponder is programmed with suitable product information.

A selectable peeler located at the dispensing location, engages the web as it advances through the dispensing location to cause the label to separate from the web for application to the advancing package. The peeler retracts to a reject position when the verification signal is absent.

### BRIEF DESCRIPTION OF THE DRAWINGS

FIG. 1 is a perspective illustration of an RFID dispensing apparatus according to the invention shown with an acceptable RFID label being transferred from a web to an article by a vacuum chuck and tamper.

FIG. 2 is a perspective illustration of the RFID dispensing apparatus shown in FIG. 1 with a rejected RFID label being carried on the web past the vacuum chuck.

FIGS. 3A and 3B are perspective schematic illustrations of the selectable RFID label dispenser shown in the peel position and the reject position respectively.

FIG. 4 is a rear perspective schematic illustration of the RFID dispenser of FIG. 3A shown in the peel position.

FIGS. 5A and 5B are enlarged, fragmentary schematic block diagrams of a peeler for the RFID label dispenser shown in respective peel and reject positions.

FIG. 6 is an elevation of the apparatus shown in FIG. 1 in the peel position.

FIG. 7 is an elevation of the apparatus shown in FIG. 4 in the reject positions.

FIG. 8 is a schematic block diagram of a controller having various inputs and outputs for operating the apparatus shown in FIG. 1.

FIG. 9 is a flow chart showing various modes of operation.

FIG. 10 is a flow chart of the encode and verification mode of operation.

FIG. 11 is a timing chart.

### DESCRIPTION OF THE INVENTION

The present invention employs a selectable RFID label applicator. U.S. Pat. No. 6,352,094 which issued Mar. 5, 2002 and entitled “Modular Label Dispensing Apparatus”, the teachings of which are incorporated herein by reference, features a modular design that couples different types of label dispensing modules to one of several label applicators using a standard chasis. The present invention features such a modular design for use with and which is compatible with an arrangement described in Gunderson et al., '094.

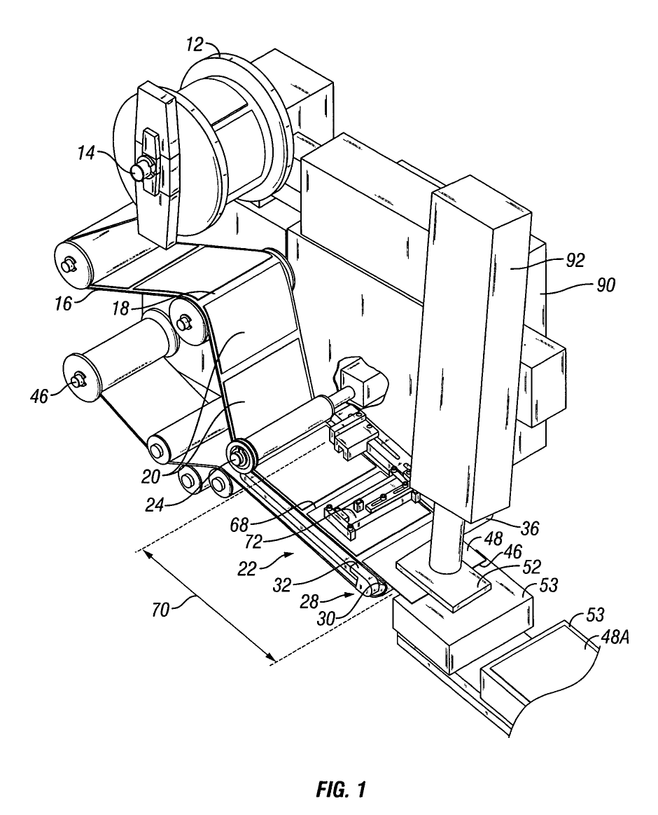

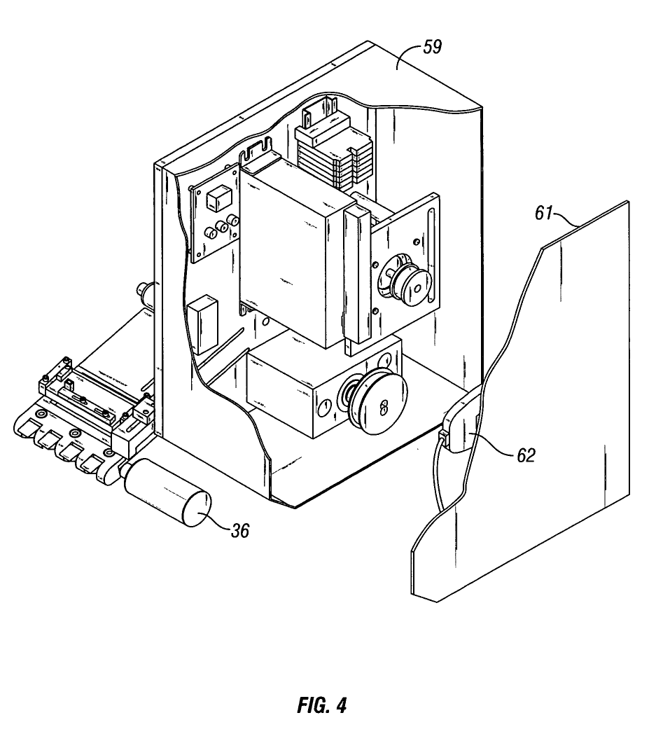

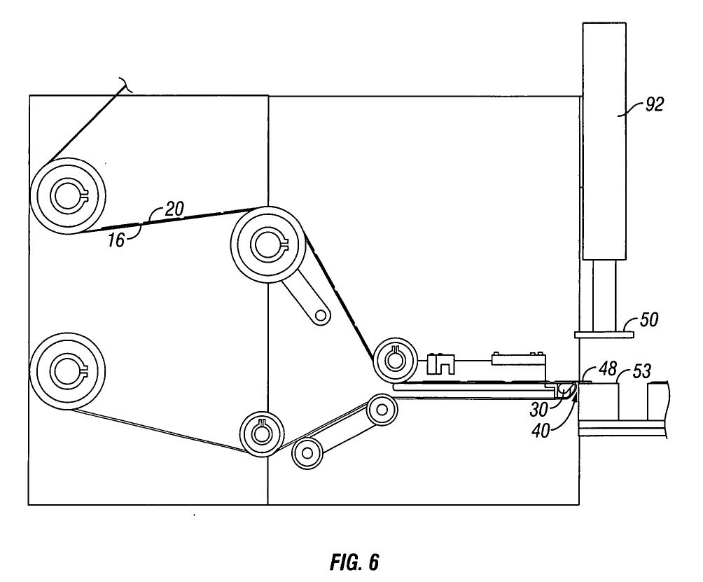

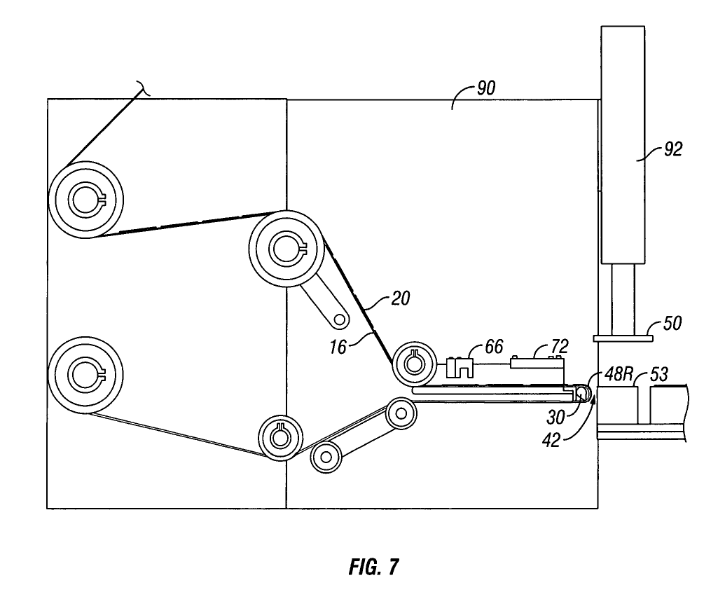

FIGS. 1-7 illustrate a selectable RFID label dispensing apparatus 10 in accordance with the invention. The apparatus includes a RFID supply in the form of a roll 12 secured on a spindle 14. The supply 12 plays out a web 16 having a carrier surface 18 and RFID labels 20 secured thereto with a suitable releasable adhesive. The web 16 passes through a drive station 22 including a drive roller 24 driven by motor 26. In and exemplary embodiment, the motor 26 is a stepper motor. However, other suitable motors may be employed such as a servo motor. The web 16 is carried to a dispensing location 28 which includes a retractable peeler 30 and a stationary or fixed reject working surface 32. The working surface 32 forms a smooth curved bearing surface which is discussed hereinafter.

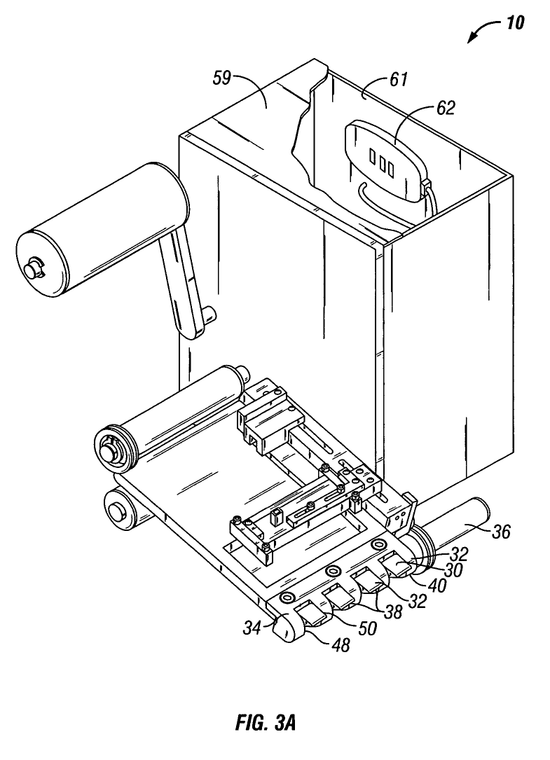

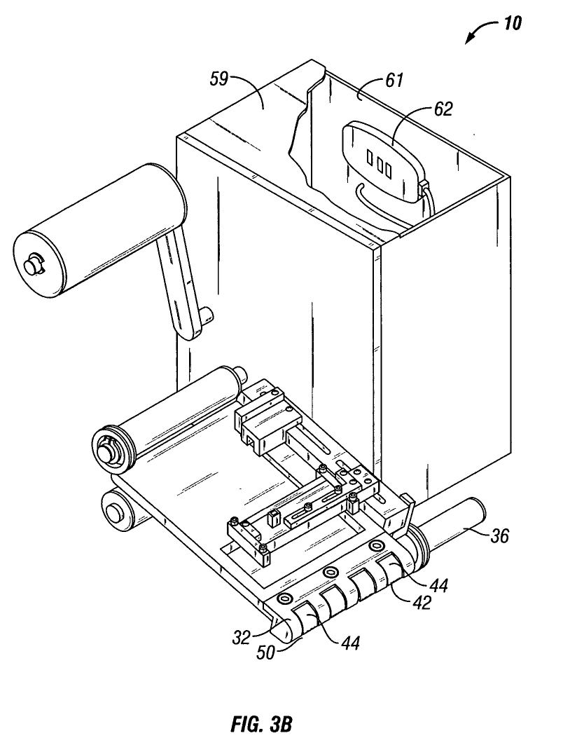

The peeler 30 shown in FIGS. 3A and 3B includes a plurality of wedge elements 34 mounted in spaced relation on a rotatable pivot shaft 35. The pivot shaft is driven between first and second positions by a reject solenoid 36. Each wedge element 34 has a distal peeler edge 38 which is rotatable with the shaft 35 between an advanced peel position 40 and a retracted reject position 42. Each peeler edge 38 extends in front of or outwardly of the working surface 32 in the peel position 40; and the peeler edge 38 is retracted behind the working surface 32 in the reject position 42. Each wedge element 34 has a curved distal surface 44 proximate to the pivot shaft 35. When the peeler 30 is positioned in the reject position 42, the distal surface 44 is positioned adjacent the reject surface 32 is disposed behind the working surface 32. The web 16 is fed through various idler rollers to the dispensing position 30, and then to a take up wheel 46 through idlers as illustrated.

The working surface 32 is formed with complementary toothed recesses 48 for receiving, one each, of the corresponding wedge elements 34 as shown. In the peel or advanced position 40, the peeler edges 38 extend from the tooted recess 48 of the working surface 32. In the reject on retracted position 42 the curved distal surfaces of the wedge elements 44 are positioned within the toothed recesses 48. The working surface 32 thus forms a smooth continuous curved surface over which the web 16 rides when the wedge elements 34 are retracted.

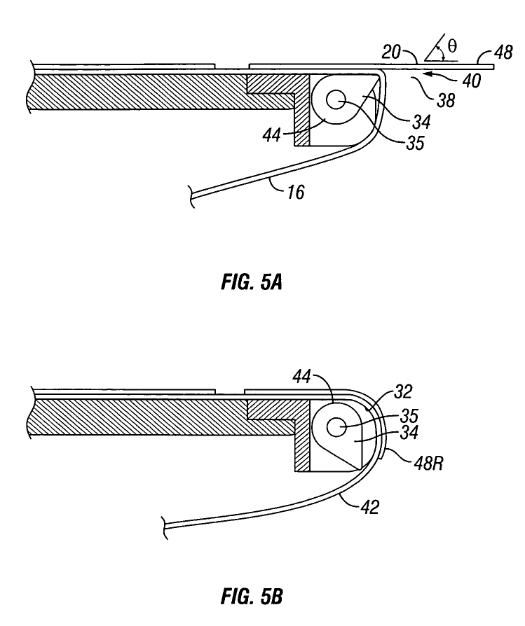

As can be seen in FIGS. 1 and 5A, when each peeler edge 38 is in the peel position 40, the peeler edges engage the rear or underside of the web 16 which passes around the relatively sharp peeler edges 38 causing the leading edge 46 of the RFID label 48 at the dispensing location 30 to separate from the web 16 as illustrated. A vacuum chuck 52, is adapted to pick up the label 48 as it peels from the web 16 for application to an advancing article 53. The RFID label 48 separates from the web 16 as a result of the sharp angle θ formed between the web 16 and the peeler edges 38 (FIG. 5A).

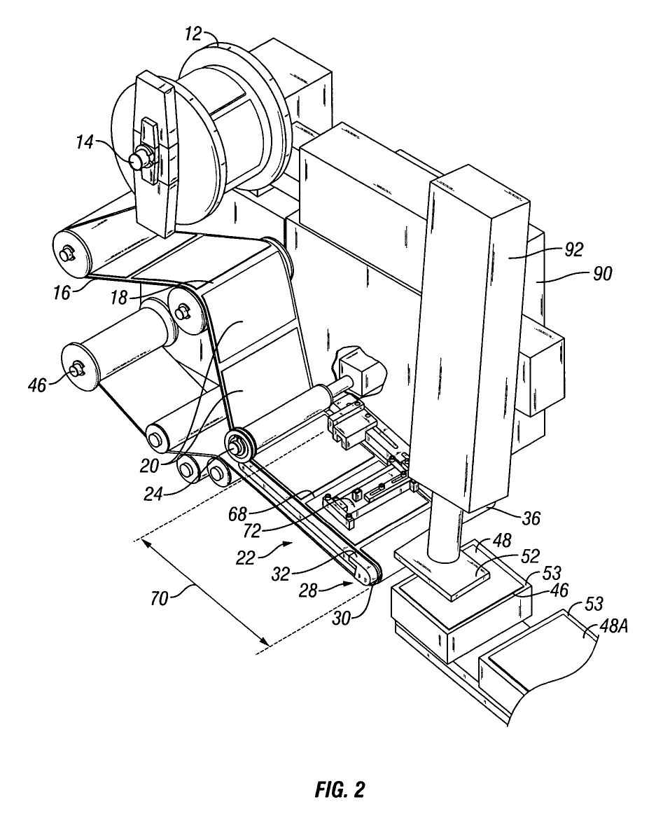

In the reject position 40, (FIGS. 2 and 5B) the peeler edges 38 are retracted behind the working surface 32. As a result, the underside of web 16 engages the smooth continuous working surface 32, such that the rejected RFID label 48R remains attached to the web 16. Hence, the so rejected label 48R is carried by the web 16 to the take up wheel 46 as illustrated. The relatively large radius of the curvature of the reject surface 32 allows the rejected label 48R to remain adhered to the web 16.

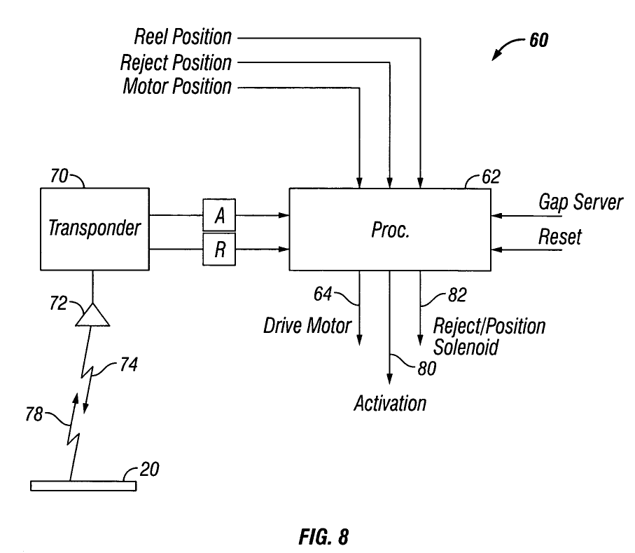

A control system 60 for the dispenser of FIGS. 1-7 is illustrated in FIG. 8. The control system 60 includes a misprocessor controller 62 which has a plurality of inputs and outputs hereinafter as discussed. The microprocessor 62 is programmable to perform various control functions. Alternatively, the microprocessor 62 may be an off-the-shelf motor controller.

The controller 60 has an output 64 coupled to the drive motor 24 for controlling the speed and advancement thereof. A gap sensor 66 (FIG. 1) is positioned adjacent the web 16 in order to detect the trailing edge 68 of each RFID label as it passes from the drive station 22 to the dispenser 30. The distance 70 of the gap sensor 64 to the peeler edge 38 in the peel position 40 is known; and the motor 26 may be controlled to position the label selectively with respect to the peeler edge 38.

A transponder unit 70 has an output antenna 72 for transmitting an activation signal 74 to the RFID label 20. If operative, the RFID label is responsive to the activation signal 74 to produce an output or verification signal 78 for transmission to the antenna 72 and the the transponder 70. If the verification signal 78 produced by the RFID 20 is correct, the transponder 70 produces an accept output A indicative of an acceptable RFID label. If the verification signal 78 is advanced to not received, the transponder 70 produces a reject output R. The accept output A and the reject output R are coupled to the processor 62 as illustrated.

In response to an accept output A, the microcontroller 62 produces an activation signal 80 for the reject solenoid 36, which causes the solenoid to position the peeler 30 so that the peel edge 38 is the peel position 30 as illustrated. In response to a reject signal R, the processor 62 produces a reject output 82 which causes the reject solenoid 36 to position the peeler edge 30 so that the peel edge 38 is retracted to the reject position 42 behind the reject surface 32. A reset to the microcontroller, conditions as each label passes through the dispenser position.

The arrangement in FIGS. 1 and 2 illustrates a modular system, similar to the arrangement in Gunderson et al., noted above. In the arrangement, a chasis 90 supports the modular selectable RFID label dispenser 10 and controller 60 discussed above. The dispenser 10 is positioned on the chasis 90 upstream of a Label Tamp 92 having vacuum chuck 52 that picks up each peeled label 48 as it separates from the web 16. Vacuum chuck 52 then applies the label 48A to advancing article 53, as shown. The dispenser 10 supports the motor 26 gap detector 66, antenna 72, and reject solenoid 36 as shown.

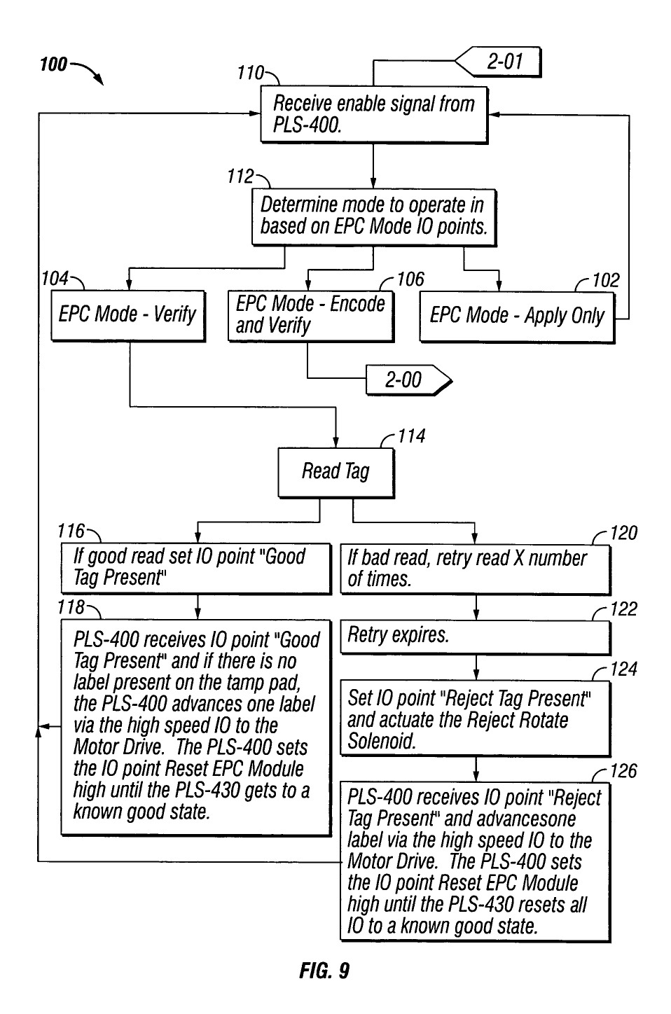

FIG. 9 illustrates a flow chart 100 for operation of the controller illustrated in FIG. 8. The present invention is operable in a variety of modes, including an electronic product code (EPC) Apply Only mode 102; an EPC Verify Mode 104; and an EPC Encode and Verify Mode 106. In the Tamp Only Mode 102, the label is simply applied to the advancing article without checking the operability of the RFID label. In the Verify mode 104, the RFID label is applied to the advancing article in accordance with the operability of the RFID, or it is rejected if inoperable. In the Encode and Verify mode 106, the RFID label is first encoded with data specific to the product and is thereafter tested to verify operability before application to the advancing article.

As illustrated in FIG. 9, an enable signal 110 initiates operation of the device. Mode selection occurs at 102. In the exemplary illustration, mode selection is to Verify Mode 104. The verification sequence includes initiating a Read Tag operation at 114, whereupon a signature is produced to activate the RFID. If the appropriate verification response is received, a Good Tag Present output is produced at 116. The Good Tag Present output causes the drive to advance one label at high speed to the application location, whereupon the label peels from the web at block 118.

It should be understood that in an exemplary embodiment, the peeler 30 defaults to the peel position 40. If the Read Tag signal 114 does not result in an appropriate response, the Bad Read block 120 produces an output which initiates a selected number of attempts at Retry block 122 to verify the operability of the tag. If after the selected number of attempts, a Bad Read signal presists, Retry 122 expires and Reject Tag Present is set at 124. The drive moves the web forward at high speed through one label position at 126. If the reject is indicated, the controller is activiated to cause the reject solenoid 36 to rotate the peeler 30 to the reject position 42, to thereby allow the RFID to remain on the web 16.

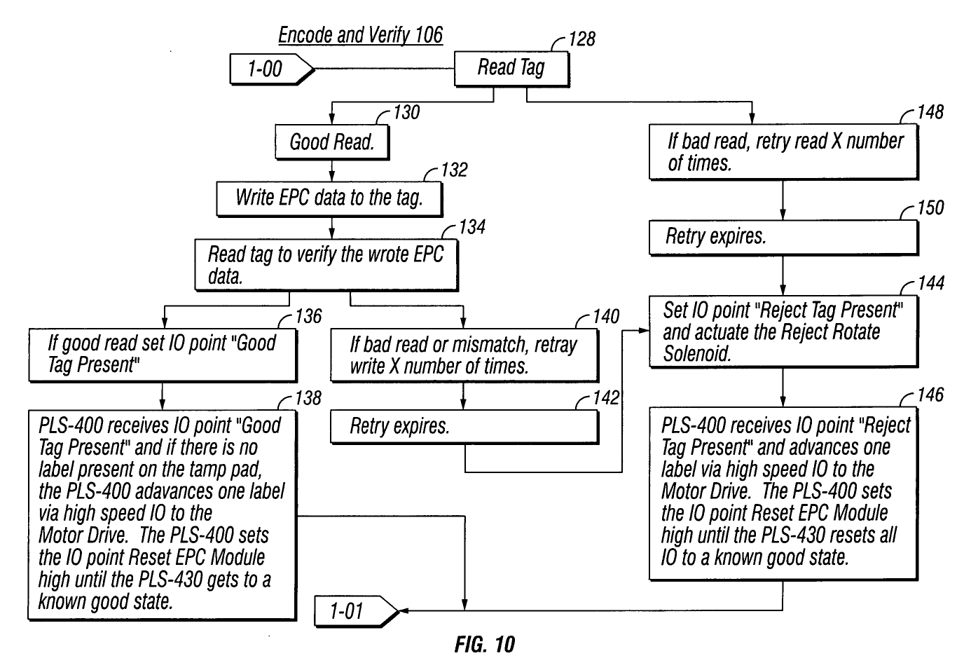

FIG. 10 illustrates the Encode and Verify mode 106 in detail. In this arrangement, the tag is read at Read Tag 128. If a Good Read 130 output is produced, write EPC Data is initated at block 132. Thereafter, the tag is read again 134 to verify that the data written on the tag is correct. If the data is correct, a Good Tag present output is set block at 136 and the controller sees a Good Tag present signal. This signal advances the web at 138 by one label that reset the module. If verification does not result in a good signal, Read Tag Block 133 produces an output. After a number of retrys at 140, Retry Expires at 142. The output of the Retry Expires 142 causes the controller to set Reject Tag present Block 144 peeler to retract and thereby reject the label at 146. In the arrangement, if the initial Read Tag step at 128 results in a Bad Read at 148, including a selected number of retrys at 150, the Reject Tag block 144 is set as well.

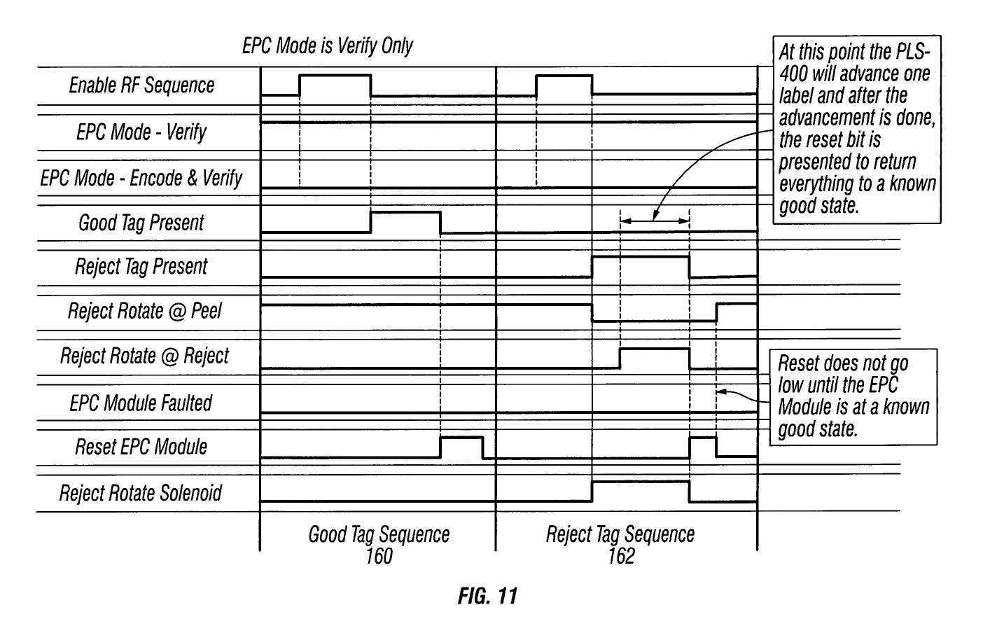

FIG. 11 illustrates a Timing sequence for the system verify mode 104. A Good Tag Sequence 160 is illustrated. The enable signal causes the initiation of a Good Tag Present signal the end of which a reset pulse is initiated. If the tag is good, the Reject Rotate is inhibited and the peeler remains at the peel position. Likewise, in the Reject Tag sequence 162, any failure of the enabler sequence to detect a verification signal causes the tag reject signal to initiate operation of the reject solenoid. Feedback is provided to allow the controller to detect the position of the reject solenoid.

While there has been described what a present is considered to be the exemplary embodiment of the invention, it will be apparent to those skilled in the art that various changes and modifications may be made therein, and it is intended in the appended claims to cover such changes and modifications as fall within the true spirit and scope of the invention.

What is the claimed is:

1. An apparatus for selecting and deselecting radio frequency identification (RFID) labels disposed on a first carrier surface of a web carrier comprising:
a frame having a working end; and
a retractable peeler being pivotally mounted on the frame adjacent the working end, said peeler being rotatable between an advanced position forward of the working end for engaging a second surface of the web opposite the carrier surface causing the label to separate from the web, and a retracted position behind the working end disengaging the second surface of the web;
the working end for engaging the second surface of the web when the peeler is in the retracted position so that the label remains disposed on the first surface when the peeler is so retracted.

2. The apparatus of claim 1 wherein the peeler comprises a wedge having a distal free end formed with a peeler edge and a proximal pivot portion pivotally secured to the frame.

3. The apparatus of claim 1 wherein the working surface includes a relatively rounded smooth surface.

4. The apparatus of claim 1 wherein the RFID labels, when operative, are responsive to an input signal to produce an output signal, further comprising a transponder circuit operative for producing the input signal for each RFID label, and being responsive to the output signal of the RFID when operative for producing a verification signal.

5. The apparatus of claim 4 further including a driver coupled to the peeler for positioning the peeler at the advanced position in response to the verification signal, and for retracting the peeler in the absence of the verification signal.

6. The apparatus of claim 1 further including an circuit for sensing operability of each RFID and producing a verification signal in response thereto.

7. The apparatus of claim 1 further including a circuit for writing information to each RFID.

8. The apparatus of claim 7 further including a circuit for reading the information written to the RFID.

9. The apparatus of claim 1 wherein the working end comprises a relatively smooth radiused surface having a plurality of slots formed therein, and the peeler comprises a wedge having a plurality of slots therein, the wedge being mated with the slots in the working end.

10. The apparatus of claim 9 wherein the slots in the working end are complementary to the slots in the wedge.

11. The apparatus of claim 10 wherein the wedge is formed with a distal free end having a relatively sharp edge for engaging the opposite side of the web.

12. The apparatus of claim 11 wherein the wedge includes a proximal pivot portion pivotally secured to the frame and a relatively smooth rounded surface portion matching the smooth rounded surface portion of the working end for engaging the second surface of the web when the wedge is retracted.

13. A control system for an RFID selector apparatus having a peeler mounted for selectable engagement with a web carrying a plurality of RFID labels peelably secured to a carrier surface thereof, said selector for selecting the RFID labels for application to an object when the label is operative, and deselecting the RFID label when it is not operative, said labels, when operative, being responsive to produce an output signal indicative of operability in response to an input signal, the control system comprising:
a signal generator for generating the input signal for each RFID label;
a transponder operative for transmitting the input signal and for receiving the output signal of the RFID label;
a peeler drive operatively coupled to the transceiver, being responsive to the output signal for extending the peeler for engagement with the web in response to the RFID output, and for retracting the peeler for disengaging the peeler from the web in the absence of the output signal from the RFID.

14. The control system of claim 13, wherein the peeler drive comprises a solenoid for driving the peeler between respective extended and retracted positions.

15. A method for selecting and deselecting radio frequency identification (RFID) labels disposed on a first carrier surface of a web carrier comprising the steps of:
stimulating each RFID with an input signal and sensing an output indicative of an operative RFID;
positioning a retractable peeler to a peel position in response to the output indicative of an operative RFID; and
positioning the peeler to a reject position in the absence of the output.

16. The method of claim 15 where in the peeler is pivotally mounted on the frame adjacent the working end, comprising:
rotating the peeler being between an advanced position forward of the working end for engaging a second surface of the web opposite the carrier surface causing the label to separate from the web, and a retracted position behind the working end disengaging the second surface of the web.

17. The method of claim 15 further comprising
engaging the second surface of the web with the working surface when the peeler is in the retracted position so that the label remains disposed on the first surface when the peeler is so retracted.

18. An apparatus for selecting and deselecting radio frequency identification (RFID) labels being disposed on a first surface of a web comprising:
a frame having a bearing surface and a working end; and
a retractable peeler, the retractable peeler being pivotally mounted on the frame adjacent the working end, and positionable between an advanced peel position forward of the working end and a retracted position behind the working end, the peeler for engaging a second surface of the carrier web opposite the first surface for causing the label to separate from the web when the peeler is in the peel position forward of the working surface; and the peeler being retractable to the retracted position behind the working surface for disengaging the second surface of the web;
the peeler comprising at least one wedge having a distal peeler edge for engaging the second surface of the web, and a proximal pivot portion pivotally secured to the frame such that the peeler edge is rotatable about the pivot between the peel position and retracted position;
the bearing surface for engaging the second surface of the web and the working end including a relatively smooth radiused surface for engaging the second surface when the peeler is in the retracted position so that the label remains disposed on the first surface when the peeler is so retracted.
